(19) United States
(12) Patent Application Publication
(10) Pub. No.: US 2023/0317934 A1
(43) Pub. Date: Oct. 5, 2023

(54) LITHIUM-METAL SECONDARY BATTERY AND METHOD FOR MANUFACTURING THE SAME

(71) Applicant: HONDA MOTOR CO., LTD., Tokyo (JP)

(72) Inventors: Kazuki SAIMEN, Saitama (JP); Ken BABA, Saitama (JP)

(21) Appl. No.: 18/190,138

(22) Filed: Mar. 27, 2023

(30) Foreign Application Priority Data
Mar. 29, 2022 (JP) 2022-054463

(51) Int. Cl. H01M 4/38; H01M 50/46; H01M 4/04; H01M 10/0525

(52) U.S. Cl. CPC H01M 4/382; H01M 50/46; H01M 4/0445; H01M 10/0525; H01M 2004/027

(57) ABSTRACT

A lithium-metal secondary battery, which includes a highly reduction-resistant electrolytic solution, including 2 to 6 mol of electrolyte per L of solvent and also having a lithium deposition dissolution efficiency of 98.5% or more, which lithium deposition dissolution efficiency is the proportion of the amount of redissolution of lithium to the amount thereof deposited on the copper surface, wherein the relative density of a lithium metal layer in a negative electrode is 40 to 85%. In addition, a lithium-metal secondary battery, which includes a highly oxidation-resistant electrolytic solution, including 2 to 6 mol of electrolyte per L of solvent and also having a voltage of 5.5 V or more when the current density is 0.4 mA/cm² using lithium as a counter electrode and platinum as a working electrode, wherein the relative density of a lithium metal layer in a negative electrode is 70 to 95%.

This application is based on and claims the benefit of priority from Japanese Patent Application 2022-054463, filed on 29 Mar. 2022, the content of which is incorporated herein by reference.

### BACKGROUND OF THE INVENTION

### Field of the Invention

The present invention relates to a lithium-metal secondary battery and a method for manufacturing the same.

Related Art

In recent years, in order for more people to secure access to reasonable, reliable, sustainable and advanced energy, secondary batteries contributing to energy efficiency have been researched and developed.

Incidentally, with respect to secondary battery technology, lithium-metal secondary batteries having a lithium metal layer on the negative electrode thereof are known. The lithium-metal secondary batteries have very high energy density compared to conventionally common lithium ion batteries, and are expected to be put to practical use. Meanwhile, unlike conventionally common carbon-based negative electrodes, the lithium-metal secondary batteries do not have a film structure maintaining member to store and release lithium ions, and lithium metal particles are deposited on a negative electrode current collector and lithium foil to form a lithium metal layer. Therefore, there are problems of, in the course of the dissolution and deposition of lithium metal due to charge and discharge, expansion and contraction of electrodes, dendrite generated on a negative electrode, and poor charge-discharge efficiency and poor charge-discharge cycle characteristics caused by, e.g., a reaction between lithium metal and an electrolyte.

In lithium-metal secondary batteries, however, a technique is suggested, which provides a space having 100 to 120% the thickness in which lithium is theoretically deposited between a negative electrode and a separator (for example, see Patent Document 1). According to this technique, it is believed that the expansion and contraction of lithium-metal secondary batteries can be eased, and thus charge-discharge efficiency and charge-discharge cycle characteristics can be improved.

In lithium-metal secondary batteries, a technique is also suggested, which uses a highly concentrated electrolytic solution, containing about 4 to 6 mol of lithium bis(fluorosulfonyl)imide (LiFSI) as an electrolyte (supporting salt) per L of organic solvent (for example, see Patent Document 2). According to this technique, it is believed that because the electrolyte is contained at a high concentration, the oxidation-reduction stability of the electrolytic solution can be improved, and charge-discharge cycle life can be extended.

Patent Document 1: Japanese Unexamined Patent Application, Publication No. 2019-192628 Patent Document 2: Japanese Unexamined Patent Application Publication (Translation of PCT Application) No. 2018-505538

### SUMMARY OF THE INVENTION

However, in the technique of Patent Document 1, because the space to prevent pressure from being applied to a lithium deposited site is provided, though expansion and contraction due to charge and discharge can be eased, lithium deposition becomes uneven, and the contact area with an electrolytic solution is increased. In particular, carbonic acid esters easily react with lithium metal, and thus the amount of the electrolytic solution decomposed is increased and charge-discharge cycle characteristics become worse.

In addition, in the technique of Patent Document 2, ether-based solvents have low oxidation resistance stability, and thus oxidative decomposition reactions can be suppressed by dissolving the electrolyte at a high concentration; however, lithium ions near a positive electrode rapidly decreases in discharge reactions, and thus charge-discharge cycle characteristics become worse.

The present invention was made in view of the above circumstances, and an object thereof is to provide a lithium-metal secondary battery, the charge-discharge cycle characteristics of which can be improved by controlling the deposition morphology of lithium and also suppressing the decomposition of a highly concentrated electrolytic solution.

(1) The present invention provides a lithium-metal secondary battery (e.g., lithium secondary battery 1 described below), including a positive electrode (e.g., positive electrode 12 described below), a negative electrode (e.g., negative electrode 10 described below) having a lithium metal layer (e.g., lithium metal layer 18 described below), a separator (e.g., separator 15 described below) positioned between the positive electrode and the negative electrode, and a highly reduction-resistant electrolytic solution (e.g., electrolytic solution 16 described below), including 2 to 6 mol of electrolyte per L of solvent and also having a lithium deposition dissolution efficiency of 98.5% or more, the lithium deposition dissolution efficiency being the proportion of the amount of redissolution of lithium with respect to the amount lithium deposited on the copper surface, wherein the relative density of the lithium metal layer is 40 to 85%.

In the lithium-metal secondary battery in (1), a highly concentrated electrolytic solution, which has high reduction resistance and is easily decomposed by oxidation, is used as an electrolytic solution, and the relative density of the lithium metal layer is set within a range of 40 to 85%. Herein, when using a highly concentrated electrolytic solution (hereinafter also referred to as highly reduction-resistant highly concentrated electrolytic solution), which has high reduction resistance and is easily decomposed by oxidation, the concentration of lithium ions near a positive electrode is easily reduced during discharge, and the effect by high concentration disappears due to the depletion of lithium ions near the positive electrode, and thus the oxidative decomposition of the electrolytic solution easily progresses. According to the lithium-metal secondary battery in (1), however, the relative density of the lithium metal layer is within a range from low density to medium density, and thus the diffusion of lithium ions redissolved from the lithium metal layer to the positive electrode can be promoted, and the uneven distribution of lithium ions on the negative electrode side can be solved, and thus a reduction in the lithium ion concentration on the positive electrode side can be suppressed. Accordingly, the progression of oxidative decomposition of the electrolytic solution on the positive electrode side can be suppressed. According to the lithium-metal secondary battery in (1), charge-discharge cycle characteristics can be improved by controlling the deposition morphology of lithium to adjust the relative density of the lithium metal layer and thus suppressing the decomposition of the highly concentrated electrolytic solution.

(2) The present invention also provides a lithium-metal secondary battery (e.g., lithium-metal secondary battery 2 described below), including a positive electrode (e.g., positive electrode 22 described below), a negative electrode (e.g., negative electrode 20 described below) having a lithium metal layer (e.g., lithium metal layer 28 described below), a separator (e.g., separator 25 described below) positioned between the positive electrode and the negative electrode, and a highly oxidation-resistant electrolytic solution (e.g., electrolytic solution 26 described below), including 2 to 6 mol of electrolyte per L of solvent and also having a voltage of 5.5 V or more when the current density is 0.4 mA/cm² using lithium as a counter electrode and platinum as a working electrode, wherein the relative density of the lithium metal layer is 70 to 95%.

In the lithium-metal secondary battery in (2), a highly concentrated electrolytic solution (hereinafter, also referred to as highly oxidation-resistant highly concentrated electrolytic solution), which has high oxidation resistance and easily reacts to lithium metal, is used as an electrolytic solution, and the relative density of the lithium metal layer is set within a range from 70 to 95%. Herein, when using a highly concentrated electrolytic solution, which has high oxidation resistance and easily reacts to lithium metal, the concentration of lithium ions near a negative electrode is easily reduced during charge, and the effect by high concentration disappears due to the depletion of lithium ions near the negative electrode, and thus the reduction decomposition of the electrolytic solution easily progresses. According to the lithium-metal secondary battery in (2), however, the relative density of the lithium metal layer is within a range from medium density to high density, and thus the diffusion of lithium ions redissolved from the lithium metal layer to the positive electrode can be suppressed, and lithium ions can be kept near the negative electrode. Accordingly, lithium ions can be always maintained at a high concentration on the negative electrode side, and simultaneously the contact area between the electrolytic solution and lithium metal can be reduced. According to the lithium-metal secondary battery in (2), therefore, charge-discharge cycle characteristics can be improved by controlling the deposition morphology of lithium to adjust the relative density of the lithium metal layer and thus suppressing the decomposition of a highly concentrated electrolytic solution.

(3) The present invention also provides a method for manufacturing a lithium-metal secondary battery (e.g., lithium-metal secondary battery 1 described below), including a positive electrode (e.g., positive electrode 12 described below), a negative electrode (e.g., negative electrode 10 described below) having a lithium metal layer (e.g., lithium metal layer 18 described below), a separator (e.g., separator 15 described below) positioned between the positive electrode and the negative electrode, and an electrolytic solution (e.g., electrolytic solution 16 described below), wherein the electrolytic solution is a highly reduction-resistant electrolytic solution, including 2 to 6 mol of electrolyte per L of solvent, and also having a lithium deposition dissolution efficiency of 98.5% or more, the lithium deposition dissolution efficiency being the proportion of the amount of redissolution of lithium with respect to the amount thereof deposited on the copper surface, the method including, in order to form the lithium metal layer (e.g., lithium metal layer 18 described below) with a relative density of 40 to 85%, a step of forming a lithium metal layer by repeating a charge-discharge cycle, having a charge rate of 0.2 C or less and a discharge rate of 0.2 C or more, by two cycles or more, under application of a load of 0.05 to 1.0 MPa.

According to the method for manufacturing a lithium-metal secondary battery in (3), a lithium metal layer with a relative density of 40 to 85% can be formed by repeating a charge-discharge cycle, having a charge rate of 0.2 C or less and a discharge rate of 0.2 C or more, by two cycles or more, under application of a load of 0.05 to 1.0 MPa. According to the method for manufacturing a lithium-metal secondary battery in (3), therefore, a lithium metal layer with a relative density of 40 to 85%, which is preferred when using a highly reduction-resistant highly concentrated electrolytic solution, can be formed by adjusting a cell confining pressure to 0.05 to 1.0 MPa, and accordingly a lithium-metal secondary battery, the charge-discharge cycle characteristics of which can be improved by suppressing the decomposition of the highly concentrated electrolytic solution, can be obtained.

(4) The present invention also provides a method for manufacturing a lithium-metal secondary battery (e.g., lithium-metal secondary battery 2 described below), including a positive electrode (e.g., positive electrode 22 described below), a negative electrode (e.g., negative electrode 20 described below) having a lithium metal layer (e.g., lithium metal layer 28 described below), a separator (e.g., separator 25 described below) positioned between the positive electrode and the negative electrode, and an electrolytic solution (e.g., electrolytic solution 26 described below), wherein the electrolytic solution is a highly oxidation-resistant electrolytic solution, including 2 to 6 mol of electrolyte per L of solvent and also having a voltage of 5.5 V or more when the current density is 0.4 mA/cm² using lithium as a counter electrode and platinum as a working electrode, the method including, in order to form the lithium metal layer (e.g., lithium metal layer 28 described below) with a relative density of 70 to 95%, a step of forming a lithium metal layer by repeating a charge-discharge cycle, having a charge rate of 0.2 C or less and a discharge rate of 0.2 C or more, by two cycles or more, under application of a load of 0.1 to 3.0 MPa, in the step of forming the lithium metal layer.

According to the method for manufacturing a lithium-metal secondary battery in (4), a lithium metal layer with a relative density of 70 to 95% can be formed by repeating a charge-discharge cycle, having a charge rate of 0.2 C or less and a discharge rate of 0.2 C or more, by two cycles or more, under application of a load of 0.1 to 3.0 MPa. According to the method for manufacturing a lithium-metal secondary battery in (4), therefore, a lithium metal layer with a relative density of 70 to 95%, which is preferred when using a highly oxidation-resistant highly concentrated electrolytic solution, can be formed by adjusting a cell confining pressure to 0.1 to 3.0 MPa, and accordingly a lithium-metal secondary battery, the charge-discharge cycle characteristics of which can be improved by suppressing the decomposition of the highly concentrated electrolytic solution, can be obtained.

According to the present invention, there can be provided a lithium-metal secondary battery, the charge-discharge cycle characteristics of which can be improved by controlling the deposition morphology of lithium and also suppressing the decomposition of a highly concentrated electrolytic solution. Consequently, it contributes to energy efficiency.

### BRIEF DESCRIPTION OF THE DRAWINGS

FIG. 1 is a diagram which shows the structure of a lithium-metal secondary battery according to the first embodiment; and

FIG. 2 is a diagram which shows the structure of a lithium-metal secondary battery according to the second embodiment.

### DETAILED DESCRIPTION OF THE INVENTION

Embodiments of the present invention will now be described in detail with reference to the drawings. It should be noted that in the descriptions of the second embodiment, the same reference symbols are provided for common structures with in the first embodiment, and the descriptions thereof are omitted.

### First Embodiment

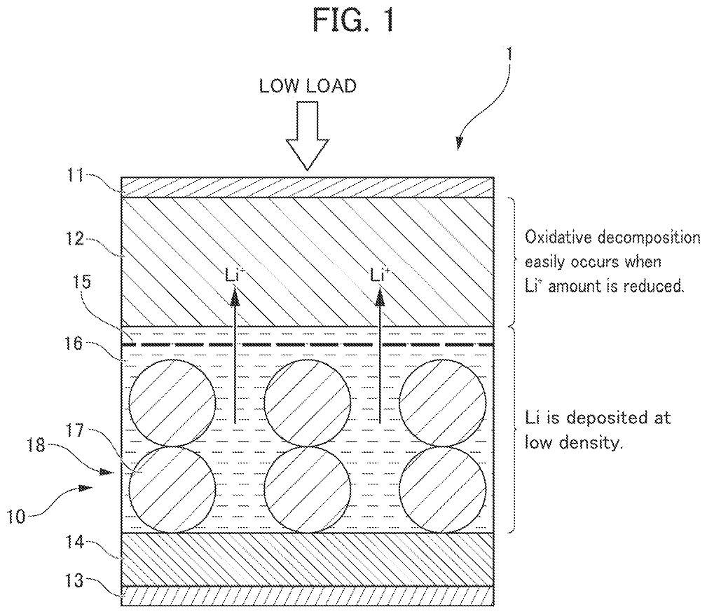

FIG. 1 is a diagram which shows the structure of a lithium-metal secondary battery 1 according to the first embodiment. The lithium-metal secondary battery 1 according to the first embodiment includes a positive electrode current collector 11, a positive electrode 12, a negative electrode current collector 13, lithium foil 14, a separator 15, an electrolytic solution 16, and a negative electrode 10 having a lithium metal layer 18 formed from lithium metal particles 17.

As the positive electrode current collector 11, a conventionally known positive electrode current collector can be used. For example, aluminum foil can be used as the positive electrode current collector 11.

The positive electrode 12 is formed from a layer including a positive electrode active material. Examples of the positive electrode active material can include a layer active material, a spinel type active material, an olivine type active material and the like, which contain lithium. Specific examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), heterogeneous element-substituted Li—Mn spinel represented by Li₁+xMn₂−x-yMyO₄ (at least one selected from x+y=2, M=Al, Mg, Co, Fe, Ni and Zn), lithium titanate (Li and Ti containing oxide), lithium metal phosphate (LiMPO₄, at least one selected from M=Fe, Mn, Co and Ni) and the like. Preferably, as the positive electrode active material, Li₁Ni_{0.8}Co_{0.1}Mn_{0.1}O₂ (NCM811) is used, and may be used in combination with a pre-doping material.

The positive electrode 12 may be formed from a layer including a binder, a conductive aid and the like in addition to the above-described positive electrode active material. Polyvinylidene difluoride (PVDF) as the binder, acetylene black (AB) as the conductive aid and the like, for example, can be used.

As the negative electrode current collector 13, a conventionally known negative electrode current collector can be used. As the negative electrode current collector 13, copper foil, for example, can be used.

The lithium foil 14 is laminated and positioned on the negative electrode current collector 13. The lithium foil 14 is not an essential structure; however, when the lithium foil 14 is provided on the negative electrode current collector 13, the deposition of the lithium metal particles 17 described below can be promoted, and the formation of the lithium metal layer 18 in the negative electrode 10 can be promoted. In addition, the adhesion of the lithium metal layer 18 in the negative electrode 10 can be improved.

The separator 15 is positioned between the positive electrode 12 and the negative electrode 10. As the separator 15, a conventionally known separator can be used. As the separator 15, for example, an alumina-coated microporous polyethylene membrane can be used.

The electrolytic solution 16 is positioned between the positive electrode 12 and the negative electrode 10. The electrolytic solution 16 is, for example, impregnated into the above-described separator 15 and positioned. The electrolytic solution 16 includes an organic solvent and an electrolyte.

About the organic solvent, for example, hydrofluoroethers such as 1,1,2,2-tetrafluoro-1-(2,2,2-trifluoroethoxy)ethane, methyl nonafluoroisobutyl ether and methyl nonafluorobutyl ether, which are fluorine-substituted chain hydrocarbons, can be used as a first organic solvent. In addition, for example, 1,2-dimethoxyethane (DME), ethylene carbonate (EC), propylene carbonate (PC), sulfolane (SL), dimethyl carbonate (DMC), diethyl carbonate (DEC), and ethylmethyl carbonate (EMC) and the like can be used as a second organic solvent. In the electrolytic solution 16 in the present embodiment, the first organic solvent and the second organic solvent can be used in combination.

The electrolyte is a supply source for lithium ions, a charge-transfer medium, and includes a lithium salt. As the lithium salt, at least one selected from the group consisting of LiFSI, LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI) and LiBC₄O₈ can be used. Among these, LiFSI can be preferably used as the electrolyte.

The electrolytic solution 16 in the present embodiment is a highly reduction-resistant highly concentrated electrolytic solution, formed from a highly concentrated electrolytic solution which has high reduction resistance and is easily decomposed by oxidation. Herein, high reduction resistance means that the lithium deposition dissolution efficiency is 98.5% or more, which is the proportion of the amount of redissolution of lithium to the amount thereof deposited on the copper surface. Specifically, high reduction resistance means that the lithium deposition dissolution efficiency is 98.5% or more, which is obtained based on the evaluation of reduction resistance of electrolytic solution described in detail in Examples described below.

High reduction resistance of the electrolytic solution 16 can be realized by adjusting the combination and the mixing ratio of the above-described organic solvents. A highly reduction-resistant electrolytic solution is obtained particularly by adjusting the combination and the mixing ratio of the above-described first organic solvent and second organic solvent. In general, electrolytic solutions mainly including an ether-based organic solvent have high reduction stability and are easily decomposed by oxidation. In addition, electrolytic solutions mainly including an ester-based organic solvent have high oxidation stability and easily react to lithium metal. In light of these characteristics, as the electrolytic solution 16, for example, the one obtained by combining a hydrofluoroether and 1,2-dimethoxyethane and adjusting the mixing ratio of the two can be preferably used.

In addition, the electrolytic solution 16 in the present embodiment is a highly concentrated electrolytic solution, including 2 to 6 mol of electrolyte per L of solvent. Because the electrolytic solution 16 contains an electrolyte at a high concentration, oxidation reduction stability is improved and charge-discharge cycle characteristics are improved.

It should be noted that the electrolytic solution 16 may contain additives. Examples of additives include a film forming material, a dispersant and the like. Specific examples of additives include e.g., LiNO₃, lithium nitrite, LiPO₂F₂, Cs—PF₆, PS, ES, DTD, lithium sulfate, LiFOB and the like.

The negative electrode 10 has the lithium metal layer 18 formed from the lithium metal particles 17. That is, the lithium metal layer 18 is a lithium metal deposited layer formed by an accumulation of the lithium metal particles 17 deposited on the negative electrode 10. Therefore, the lithium foil 14 previously laminated on the negative electrode current collector 13 is not included in the lithium metal layer 18 in the present embodiment.

The relative density of the lithium metal layer 18 is 40 to 85%. That is, in the lithium metal layer 18 in the present embodiment, the relative density is set to a range from low density to medium density by controlling the deposition morphology of lithium metal deposited on the negative electrode 10. Herein, the relative density is real density relative to true density, and is represented by relative density %=(real density/true density)×100. That is, the relative density means the packing rate %.

The action effect of the lithium-metal secondary battery 1 in the present embodiment will now be described in detail with reference to FIG. 1.

As described above, in the lithium-metal secondary battery 1 in the present embodiment, a highly reduction-resistant highly concentrated electrolytic solution, which has high reduction resistance and is easily decomposed by oxidation, is used as the electrolytic solution 16, and the relative density of the lithium metal layer 18 is set within a range of 40 to 85%. Conventionally, when using a highly reduction-resistant highly concentrated electrolytic solution, which has high reduction resistance and is easily decomposed by oxidation, the concentration of lithium ions near a positive electrode is easily reduced at the time of discharge, and the effect by high concentration disappears due to the depletion of lithium ions near the positive electrode, and thus the oxidation decomposition of the electrolytic solution easily progresses.

According to the lithium-metal secondary battery 1 in the present embodiment, however, the relative density of the lithium metal layer 18 is set within a range from low density to medium density, and thus the diffusion of lithium ions redissolved from the lithium metal layer 18 to the positive electrode 12 can be promoted. Because of this, the uneven distribution of lithium ions on the negative electrode 10 side can be solved, and a reduction in the lithium ion concentration on the positive electrode 12 side can be suppressed. Accordingly, the progression of oxidative decomposition of the electrolytic solution 16 on the positive electrode 12 side can be suppressed. According to the lithium-metal secondary battery 1 in the present embodiment, charge-discharge cycle characteristics can be improved by controlling the deposition morphology of lithium to adjust the relative density of the lithium metal layer 18 and thus suppressing the decomposition of the highly concentrated electrolytic solution.

It should be noted that the lithium-metal secondary battery 1 in the present embodiment can be manufactured by a manufacturing method, which is characterized in that a step of forming a lithium metal layer is provided for a conventionally common method for manufacturing a lithium ion battery. Specifically, in the step of forming a lithium metal layer in the manufacturing method in the present embodiment, a charge-discharge cycle, having a charge rate of 0.2 C or less and a discharge rate of 0.2 C or more, is repeated by two cycles or more under application of a load of 0.05 to 1.0 MPa to the lithium-metal secondary battery cell. As described above, the lithium metal layer 18 with a relative density of 40 to 85% can be formed by controlling a cell confining pressure to a range of 0.05 to 1.0 MPa. That is, the relative density of the lithium metal layer 18 can be adjusted in an early forming step, and by doing this, the effect as described above can be certainly obtained.

### Second Embodiment

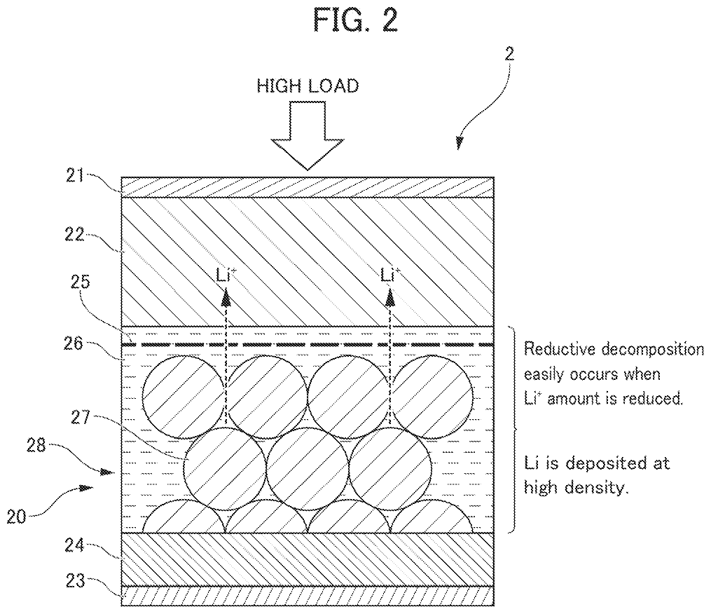

FIG. 2 is a diagram which shows the structure of a lithium-metal secondary battery 2 according to the second embodiment. The lithium-metal secondary battery 2 according to the second embodiment includes a positive electrode current collector 21, a positive electrode 22, a negative electrode current collector 23, lithium foil 24, a separator 25, an electrolytic solution 26, and a negative electrode 20 having a lithium metal layer 28 formed from lithium metal particles 27. Compared to the lithium-metal secondary battery 1 in the first embodiment, the lithium-metal secondary battery 2 in the present embodiment has the same structure as in the first embodiment except that the structures of the electrolytic solution 26 and the lithium metal layer 28 formed from the lithium metal particles 27 are different. The structures and action effect different from those of the first embodiment only will now be described in detail.

The electrolytic solution 26 is positioned between the positive electrode 22 and the negative electrode 20. The electrolytic solution 26 is, for example, impregnated into the above-described separator 25 and positioned. The electrolytic solution 26 includes an organic solvent and an electrolyte. The organic solvent and electrolyte can be selected from those described in the first embodiment. In addition, the electrolytic solution 26 may properly contain the above-described additives as is the case with the electrolytic solution 16 in the first embodiment.

The electrolytic solution 26 in the present embodiment is a highly oxidation-resistant highly concentrated electrolytic solution, which has high oxidation resistance and easily reacts to lithium metal. Herein, high oxidation resistance means that when the current density is 0.4 mA/cm² using lithium as a counter electrode and platinum as a working electrode, the voltage is 5.5 V or more. Specifically, high oxidation resistance means that the oxidative decomposition potential is 5.5 V or more, which is obtained based on the evaluation of oxidation resistance of electrolytic solution described in detail in Examples described below.

High oxidation resistance of the electrolytic solution 26 can be realized by adjusting the combination and mixing ratio of the above-described organic solvents. A highly oxidation-resistant electrolytic solution is obtained particularly by adjusting the combination and mixing ratio of the above-described first organic solvent and second organic solvent. In general, electrolytic solutions mainly including an ether-based organic solvent have high reduction stability and are easily decomposed by oxidation. In addition, electrolytic solutions mainly including an ester-based organic solvent have high oxidation stability and easily react to lithium metal. In light of these characteristics, as the electrolytic solution 26, for example, dimethyl carbonate (DMC) can be preferably used.

In addition, the electrolytic solution 26 in the present embodiment is a highly concentrated electrolytic solution, including 2 to 6 mol of electrolyte per L of solvent as is the case with the electrolytic solution 16 in the first embodiment. Because the electrolytic solution 26 contains an electrolyte at a high concentration, oxidation reduction stability is improved and charge-discharge cycle characteristics are improved.

The negative electrode 20 has the lithium metal layer 28 formed from the lithium metal particles 27. That is, the lithium metal layer 28 is a lithium metal deposited layer formed by an accumulation of the lithium metal particles 17 deposited on the negative electrode 20. Therefore, the lithium foil 24 previously laminated on the negative electrode current collector 23 is not included in the lithium metal layer 28 in the present embodiment. This is similar to the first embodiment.

The relative density of the lithium metal layer 28 is 70 to 95%. That is, in the lithium metal layer 28 in the present embodiment, the relative density is set to a range from medium density to high density by controlling the deposition morphology of lithium metal deposited on the negative electrode 20.

The action effect of the lithium secondary battery 2 in the present embodiment will now be described in detail with reference to FIG. 2.

As described above, in the lithium-metal secondary battery 2 in the present embodiment, a highly oxidation-resistant highly concentrated electrolytic solution, which has high oxidation resistance and easily reacts to lithium metal, is used as the electrolytic solution 26, and the relative density of the lithium metal layer 28 is set within a range of 70 to 95%. Conventionally, when using a highly concentrated electrolytic solution, which has high oxidation resistance and easily reacts to lithium metal, the concentration of lithium ions near a negative electrode is easily reduced at the time of charge, and the effect by high concentration disappears due to the depletion of lithium ions near the negative electrode, and thus the oxidation decomposition of the electrolytic solution easily progresses.

According to the lithium-metal secondary battery 2 in the present embodiment, however, the relative density of the lithium metal layer 28 is set within a range from medium density to high density, and thus the diffusion of lithium ions redissolved from the lithium metal layer 28 to the positive electrode 22 can be suppressed. Because of this, lithium ions can be kept near the negative electrode 20, and accordingly, lithium ions can be always maintained at a high concentration on the negative electrode 20 side, and simultaneously the contact area between the electrolytic solution 26 and lithium metal can be reduced. According to the lithium-metal secondary battery 2 in the present embodiment, therefore, charge-discharge cycle characteristics can be improved by controlling the deposition morphology of lithium to adjust the relative density of the lithium metal layer 28 and thus suppressing the decomposition of the highly concentrated electrolytic solution.

It should be noted that the lithium-metal secondary battery 2 in the present embodiment can be manufactured by a manufacturing method, which is characterized in that a step of forming a lithium metal layer is provided for a conventionally common method for manufacturing a lithium ion battery. Specifically, in the step of forming a lithium metal layer in the manufacturing method in the present embodiment, a charge-discharge cycle, having a charge rate of 0.2 C or less and a discharge rate of 0.2 C or more, is repeated by two cycles or more under application of a load of 0.1 to 3.0 MPa to the lithium-metal secondary battery cell. As described above, the lithium metal layer 28 with a relative density of 70 to 95% can be formed by controlling a cell confining pressure to a range of 0.1 to 3.0 MPa. That is, the relative density of the lithium metal layer 28 can be adjusted in an early forming step, and by doing this the effect as described above can be certainly obtained.

The present invention is not limited to the above embodiments, and variations and improvements are included in the present invention as long as the object of the present invention can be achieved.

### EXAMPLES

Examples of the present invention will now be described. It should be noted, however, that the present invention is not limited to these Examples.

### Examples 1 to 5, Comparative Examples 1 to 5

### Preparation of Electrolytic Solution

First, an electrolytic solution used in each of Examples and Comparative Examples was prepared. Specifically, electrolytic solutions EL-a, EL-b, EL-c, EL-d and EL-e were prepared by mixing materials shown in Table 1 below in mass ratios shown in Table 1. It should be noted that the electrolyte concentration mol/L of each electrolytic solution was as shown in Table 2 below.

TABLE 1

| Material name | Abbreviation | EL-a | EL-b | EL-c | EL-d | EL-e |
|---|---|---|---|---|---|---|
| Lithium bis(fluorosulfonyl)imide | LiFSI | 39.5% | 50.9% | 48.6% | 24.6% | 20.8% |
| 1,2-Dimethoxyethane | DME | 39.5% | — | 33.5% | 49.2% | — |
| Hydrofluoroether | HFE | 19.7% | — | — | 24.6% | — |
| Lithium nitrate | LNO | 1.0% | — | 0.8% | 1.2% | — |
| Lithium difluorophosphate | LPO | 0.3% | — | 0.3% | 0.4% | — |
| Dimethyl carbonate | DMC | — | 49.1% | 16.8% | — | 79.2% |

### Evaluation of Reduction Resistance of Electrolytic Solution

Each of electrolytic solutions EL-a, EL-b, EL-c, EL-d and EL-e shown in Table 1 was impregnated into a separator having an alumina-coated microporous polyethylene membrane. From copper foil with a thickness of 8 μm, a circle with a diameter of 18 mm was punched out, and a circle with a diameter of 14 mm was punched out from a clad material having lithium foil with a thickness of 40 μm and copper foil with a thickness of 10 μm. Subsequently, the separator impregnated with an electrolytic solution was put between the punched-out copper foil and clad material, with copper and lithium positioned facing each other, to produce a coin cell.

The coin cell was produced and then allowed to stand at 25° C. for an hour. The coin cell was connected to terminals so that the copper electrode was the positive electrode and the lithium electrode was the negative electrode. Subsequently, the following (1) to (10) operations were performed in order:
(1) a constant current discharge at 0.24 mA/cm² for 10 hours,
(2) a pause for 5 minutes,
(3) a constant current charge at 0.24 mA/cm² until reaching 1.0 V,
(4) a constant current discharge at 0.24 mA/cm² for 10 hours,
(5) a constant current charge at 0.24 mA/cm² for an hour,
(6) a pause for 5 minutes,
(7) a constant current discharge at 0.24 mA/cm² for an hour,
(8) a pause for 5 minutes,
(9) performing a total of 10 cycles of (5) to (8), and
(10) a constant current charge at 0.24 mA/cm² until reaching 1.0 V.

After the above (1) to (10) operations, the lithium deposition dissolution efficiency was calculated, which is the proportion of the amount of redissolution of lithium to the amount thereof deposited on the copper surface. Specifically, as shown in Formula 1 below, the lithium deposition dissolution efficiency was calculated from the ratio of the discharge capacity obtained from the constant current discharge in (4) above to the charge capacity obtained from the constant current charge in (10) above.

[Math 1]

Lithium deposition dissolution efficiency (%)={discharge capacity in (4)/charge capacity in (10)}×100 Formula 1.

### Evaluation of Oxidation Resistance of Electrolytic Solution

A microcell for analysis manufactured by EC FRONTIER CO., LTD was used as an evaluating cell. A platinum wire electrode with a diameter of 3 mm for a working electrode, and a material obtained by processing the clad material of lithium and copper used for the evaluation of reduction resistance into a size of 10 mm×5 mm for a counter electrode were used, and 2 mL of an electrolytic solution was used. As a method for evaluation, linear sweep voltammetry (LSV) was used. The temperature was 25° C. and the voltage range was swept from the open circuit voltage (OCV) to 5.5 V. A voltage when a current value of 0.4 mA/cm² was detected at a scan rate of 1.0 mV/s (oxidative decomposition potential) was measured.

The evaluation results of reduction resistance and the evaluation results of oxidation resistance in each electrolytic solution described above were shown in Table 2 below. It should be noted that electrolytic solutions having a lithium deposition dissolution efficiency of 98.5% or more, obtained by the evaluation of reduction resistance, were judged as a highly reduction-resistant electrolytic solution (described as reduction resistance in Table 2), and electrolytic solutions having an oxidative decomposition potential of 5.5 V or more, obtained by the evaluation of oxidation resistance, were judged as a highly oxidation-resistant electrolytic solution (described as oxidation resistance in Table 2). In addition, an electrolytic solution, which was not judged as either the highly reduction-resistant electrolytic solution or the highly oxidation-resistant electrolytic solution, was described as not applicable.

TABLE 2

| | EL-a | EL-b | EL-c | EL-d | EL-e |
|---|---|---|---|---|---|
| Salt | 4 | 6 | 5.8 | 2 | 1.5 |
| concentration | | | | | |
| mol/L | | | | | |
| Li deposition | 99.1 | 86.9 | 98.0 | 98.5 | 84.0 |
| dissolution | | | | | |
| efficiency % | | | | | |
| Oxidative | 5.3 | 5.5 | 5.4 | 5.3 | 5.5 |
| decomposition | | | | | |
| potential V | | | | | |
| Judgement | Reduction | Oxidation | Not | Reduction | Oxidation |
| | resistance | resistance | applicable | resistance | resistance |

### Production of Positive Electrode

Acetylene black (AB) as an electron conductive material, polyvinylidene difluoride (PVDF) as a binding agent (binder), and polyvinylpyrrolidone (PVP) as a dispersant were pre-mixed in N-methyl-2-pyrrolidone (NMP) as a dispersing solvent, and wet blending was performed by a planetary centrifugal mixer to obtain a premixed slurry. Subsequently, the obtained premixed slurry, Li₁Ni_{0.8}Co_{0.1}Mn_{0.1}O₂ (NCM811) as a positive electrode active material, and a pre-doping material were mixed, and the obtained mixture was subjected to dispersion treatment using a planetary mixer to obtain a positive electrode paste. It should be noted that the median diameter of NCM811 was 12 μm.

Next, the obtained positive electrode paste was applied to a positive electrode current collector, not having a primer layer and made from aluminum, and dried, and pressure was applied thereto by roll pressing, followed by drying at 120° C. in a vacuum to produce a positive electrode plate provided with a positive electrode mixture layer. A size of 30 mm×40 mm was punched out from the obtained positive electrode plate to obtain a positive electrode.

### Production of Negative Electrode

An electrode area with a size of 34 mm×44 mm was punched out from a clad material having copper foil with a thickness of 10 μm and lithium foil with a thickness of 20 μm to obtain a negative electrode.

### Production of Separator

An alumina-coated microporous polyethylene membrane was produced as a separator.

### Assembly of Cell and Production of Lithium-Metal Secondary Battery

A cell was assembled using the above-described positive electrode, negative electrode, separator and electrolytic solution to produce a lithium-metal secondary battery in each of Examples and Comparative Examples. In each of Examples and Comparative Examples, specifically, a cell was assembled by using each electrolytic solution as shown in Table 3 below and setting a cell confining pressure (surface pressure) at the time of aging as shown in Table 3 to produce a lithium-metal secondary battery in each of Examples and Comparative Examples.

### Formation of Lithium Metal Layer (Deposited Layer)

A lithium-metal secondary battery in each of Examples and Comparative Examples produced as described above was held at a cell confining pressure shown in Table 3 and allowed to stand at a measurement temperature of 25° C. for 24 hours. Next, a constant current charge was performed at 2.2 mA to 4.3 V, and a constant voltage charge was then performed at a voltage of 4.3 V for an hour. After the battery was allowed to stand for 30 minutes, a constant current discharge was performed at a current value of 8.8 mA to 2.65 V. This was repeated three times to form a lithium metal layer (deposited layer).

### Calculation of Relative Density of Lithium Metal Layer (Deposited Layer)

After forming the lithium metal layer (deposited layer) as described above, a constant current charge was performed at 14.7 mA to 4.3 V, and a constant voltage charge was then performed at voltage of 4.3 V for an hour. Next, the cell was broken up after allowed to stand for 30 minutes, and the thickness T1 of the lithium metal layer (deposited layer) was measured. It should be noted that the total thickness of the negative electrode was measured using a micro-gauge, and the thickness of lithium foil and copper foil, 30 μm, was subtracted from the measured value to measure the thickness T1 of the lithium metal layer (deposited layer).

In addition, the amount of deposited lithium was the sum total of charge capacity—the sum total of discharge capacity, and the theoretical thickness T2 of the lithium metal layer (deposited layer) was calculated by Formula 2 below. Herein, the facing area was 12 cm², the theoretical capacity density of lithium metal was 3860 mAh/g, and the true density of lithium was 0.5073 g/cc.

[Math 2]

Theoretical thickness T2 of lithium metal layer (deposited layer)=deposited lithium capacity (mAh)/facing area/theoretical capacity density of lithium metal/true density of lithium Formula 2.

The relative density of the lithium metal layer (deposited layer) was calculated by Formula 3 below using the thickness T1 of the lithium metal layer (deposited layer) and the theoretical thickness T2 of the lithium metal layer (deposited layer) obtained as described above.

[Math 3]

Relative density of lithium metal layer (deposited layer)=T1/T2×100(%) Formula 3.

### Initial Performance Evaluation (Discharge Capacity)

A lithium-metal secondary battery in each of Examples and Comparative Examples was allowed to stand at a hold pressure of 0.8 MPa at a measurement temperature of 25° C. for an hour, and a constant current charge was then performed at 14.7 mA to 4.3 V. Subsequently, a constant voltage charge was performed at a voltage of 4.3 V for an hour, and the battery was allowed to stand for 30 minutes. A constant current discharge was then performed at a current value of 14.7 mA to 2.65 V, and the discharge capacity at this time was measured as the initial discharge capacity (mAh). It should be noted that the current value, when the discharge of the obtained discharge capacity can be completed for an hour, was considered 1 C. The results were shown in Table 3.

### Initial Specific Resistance

A lithium-metal secondary battery cell after measuring its initial capacity was allowed to stand at a measurement temperature of 25° C. for an hour, and a constant current charge was then performed at 0.2 C. The state of charge (SOC) was adjusted to 50%, and the cell was allowed to stand for 10 minutes. Next, a pulse discharge was performed at 0.5 C for 10 seconds, and the voltage at this time was measured. The current was plotted along the abscissa and the voltage when a pulse discharge was performed at 0.5 C for 10 seconds was plotted along the ordinate. Next, the lithium-metal secondary battery cell was allowed to stand for 10 minutes, and an auxiliary charge was then performed. The SOC was returned to 50%, and the cell was then allowed to stand for another 10 minutes. The above operations were performed at each C rate of 1.0 C, 1.5 C, 2.0 C, 2.5 C and 3.0 C, and the results were plotted as described above. The inclination of the approximation straight line by the least square method obtained from plots was obtained, and used as the initial resistance of the lithium-metal secondary battery cell. A value obtained by multiplying the initial resistance by the electrode facing area was used as the initial specific resistance. The results were shown in Table 3.

### Performance Evaluation After Endurance (Discharge Capacity)

A lithium-metal secondary battery in each of Examples and Comparative Examples was subjected to a charge-discharge cycle endurance test. Specifically, an operation of a constant current charge in a 45° C. constant temperature bath at a charge rate of 1 C to 4.2 V and then a constant current discharge at a discharge rate of 2 C to 2.65 V was considered one cycle, and this was repeated 20 cycles. After completing 20 cycles, the constant temperature bath was changed to 25° C., the battery was allowed to stand for 24 hours, and a constant current charge was then performed at 0.33 C to 4.2 V. Subsequently, a constant voltage charge was performed at a voltage of 4.2 V for an hour, and the battery was allowed to stand for 5 minutes. A constant current discharge was then performed at a discharge rate of 0.33 C to 2.5 V to measure the discharge capacity after endurance (mAh). The results were shown in Table 3.

### Capacity Retention Rate After Endurance

The proportion of the discharge capacity after endurance (mAh) to the above-described initial discharge capacity (mAh) was obtained, and the capacity retention rate after endurance (%) was calculated. The results were shown in Table 3.

TABLE 3

| | | Comparative | Comparative | Comparative | Comparative | Comparative |
|---|---|---|---|---|---|---|
| | | Example 1 | Example 2 | Example 3 | Example 4 | Example 5 |
| Negative | Li relative | 90 | 65 | 97 | 85 | 70 |
| electrode | density % | | | | | |
| Cell | Surface | 2.0 | 0.08 | 4.0 | 1.0 | 0.1 |
| constraint | pressure | | | | | |
| in aging | Mpa | | | | | |
| Electrolyte | Solvent | EL-a | EL-b | EL-b | EL-c | EL-e |
| | type | | | | | |
| | Judgement | Reduction | Oxidation | Oxidation | Not | Oxidation |
| | | resistance | resistance | resistance | applicable | resistance |
| Initial | Capacity | 45.9 | 45.6 | 46.9 | 46.1 | 47.2 |
| performance | mAh | | | | | |
| | Specific | 41.0 | 22.1 | 49.3 | 33.7 | 17.0 |
| | resistance | | | | | |
| | Ω · cm² | | | | | |
| After | Capacity | 32 | 23 | 3 | 32 | 2 |
| endurance | mAh | | | | | |
| | Capacity | 70 | 50 | 6 | 70 | 5 |
| | retention | | | | | |
| | rate % | | | | | |

| | | Example 1 | Example 2 | Example 3 | Example 4 | Example 5 |
|---|---|---|---|---|---|---|
| Negative | Li relative | 40 | 85 | 70 | 95 | 85 |
| electrode | density % | | | | | |
| Cell | Surface | 0.05 | 1.0 | 0.1 | 3.0 | 1.0 |
| constraint | pressure | | | | | |
| in aging | Mpa | | | | | |
| Electrolyte | Solvent | EL-a | EL-a | EL-b | EL-b | EL-d |
| | type | | | | | |
| | Judgement | Reduction | Reduction | Oxidation | Oxidation | Reduction |
| | | resistance | resistance | resistance | resistance | resistance |
| Initial | Capacity | 45.5 | 46.0 | 46.1 | 45.6 | 45.5 |
| performance | mAh | | | | | |
| | Specific | 33.5 | 39.7 | 27.3 | 22.1 | 29.0 |
| | resistance | | | | | |
| | Ω · cm² | | | | | |
| After | Capacity | 45 | 46 | 46 | 46 | 45 |
| endurance | mAh | | | | | |
| | Capacity | 98.8 | 99.0 | 99.0 | 99.8 | 99.0 |
| | retention | | | | | |
| | rate % | | | | | |

As shown in Table 3, it was found that all the lithium secondary batteries in Examples had higher capacity retention rates after endurance than those of the lithium-metal secondary batteries in Comparative Examples. Therefore, it was found that according to the lithium-metal secondary batteries in Examples, charge-discharge cycle characteristics could be improved by adjusting the cell confining pressure depending on the characteristics of each electrolytic solution to adjust the relative density of a lithium metal layer and thus suppressing the decomposition of the electrolytic solution on the electrode surface.

### EXPLANATION OF REFERENCE NUMERALS

1, 2 Lithium-metal secondary battery
10, 20 Negative electrode
11, 21 Positive electrode current collector
12, 22 Positive electrode
13, 23 Negative electrode current collector
14, 24 Lithium foil
15, 25 Separator
16, 26 Electrolytic solution
17, 27 Lithium metal particles
18, 28 Lithium metal layer

What is claimed is:

1. A lithium-metal secondary battery, comprising,
a positive electrode,
a negative electrode having a lithium metal layer,
a separator positioned between the positive electrode and the negative electrode, and
a highly reduction-resistant electrolytic solution, comprising 2 to 6 mol of electrolyte per L of solvent and also having a lithium deposition dissolution efficiency of 98.5% or more, the lithium deposition dissolution efficiency being a proportion of an amount of redissolution of lithium with respect to an amount thereof deposited on a copper surface,
wherein a relative density of the lithium metal layer is 40 to 85%.

2. A lithium-metal secondary battery, comprising,
a positive electrode,
a negative electrode having a lithium metal layer,
a separator positioned between the positive electrode and the negative electrode, and
a highly oxidation-resistant electrolytic solution, comprising 2 to 6 mol of electrolyte per L of solvent and also having a voltage of 5.5 V or more when a current density is 0.4 mA/cm² using lithium as a counter electrode and platinum as a working electrode,
wherein a relative density of the lithium metal layer is 70 to 95%.

3. A method for manufacturing a lithium-metal secondary battery, comprising a positive electrode, a negative electrode having a lithium metal layer, a separator positioned between the positive electrode and the negative electrode, and an electrolytic solution,
wherein the electrolytic solution is a highly reduction-resistant electrolytic solution, comprising 2 to 6 mol of electrolyte per L of solvent and also having a lithium deposition dissolution efficiency of 98.5% or more, the lithium deposition dissolution efficiency being a proportion of an amount of redissolution of lithium with respect to an amount thereof deposited on a copper surface,
the method comprising, in order to form the lithium metal layer with a relative density of 40 to 85%, a step of forming a lithium metal layer by repeating a charge-discharge cycle, having a charge rate of 0.2 C or less and a discharge rate of 0.2 C or more, by two cycles or more, under application of a load of 0.05 to 1.0 MPa.

4. A method for manufacturing a lithium-metal secondary battery, comprising a positive electrode, a negative electrode having a lithium metal layer, a separator positioned between the positive electrode and the negative electrode, and an electrolytic solution,
wherein the electrolytic solution is a highly oxidation-resistant electrolytic solution, comprising 2 to 6 mol of electrolyte per L of solvent and also having a voltage of 5.5 V or more when a current density is 0.4 mA/cm² using lithium as a counter electrode and platinum as a working electrode,
the method comprising, in order to form the lithium metal layer with a relative density of 70 to 95%, a step of forming a lithium metal layer by repeating a charge-discharge cycle, having a charge rate of 0.2 C or less and a discharge rate of 0.2 C or more, by two cycles or more, under application of a load of 0.1 to 3.0 MPa.
